(19) United States
(12) Patent Application Publication
(10) Pub. No.: US 2020/0065787 A1
(43) Pub. Date: Feb. 27, 2020

(54) DISTRIBUTED AUTOMATED TELLER MACHINES

(71) Applicant: NCR Corporation, Atlanta, GA (US)

(72) Inventors: Tomasz Kruczek, Fremont, CA (US); Tim Gerlach, Walnut Creek, CA (US); Husam M. Ali Ibrahim, San Francisco, CA (US); Garrett Paul Schubiner, Burlingame, CA (US)

(21) Appl. No.: 16/112,752

(22) Filed: Aug. 26, 2018

(51) Int. Cl. G06Q 20/10; G06Q 20/40

(52) U.S. Cl. CPC G06Q 20/1085; G06Q 20/40145

(57) ABSTRACT

Disclosed are automated teller machines (ATMs) and systems. The ATMs and systems may include a media storage unit, an ATM head, and a media tube. The media tube may operatively connect the media storage to the ATM head. The ATM head may comprise a controller to control operation of the ATMs and systems. The controller may be operable to cause the ATMs and systems to perform actions comprising: receiving authentication information associated with a user of the ATMs and systems, authenticating the user of the ATMs and systems using the authentication information, and processing a transaction after the user has been authenticated. The media storage unit may be located remotely from the ATM head.

### SUMMARY

Disclosed are automated teller machines (ATMs) and systems. The ATMs and systems may include a media storage unit, an ATM head, and a media tube. The media tube may operatively connect the media storage to the ATM head. The ATM head may comprise a controller to control operation of the ATMs and systems. The controller may be operable to cause the ATMs and systems to perform actions comprising: receiving authentication information associated with a user of the ATMs and systems, authenticating the user of the ATMs and systems using the authentication information, and processing a transaction after the user has been authenticated. The media storage unit may be located remotely from the ATM head.

### BRIEF DESCRIPTION OF THE FIGURES

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 shows an example schematic of a system consistent with this disclosure.

FIG. 2 shows an example schematic of a controller consistent with this disclosure.

FIG. 3 shows an example method consistent with this disclosure.

Corresponding reference characters indicate corresponding parts throughout the several views. The exemplifications set out herein illustrate exemplary embodiments of the invention, and such exemplifications are not to be construed as limiting the scope of the invention any manner.

### DETAILED DESCRIPTION

The following detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the disclosed systems. Accordingly, the following detailed description does not limit this disclosure. Instead, the proper scope of any invention disclosed herein is defined by the appended claims.

Drive-up banking may be based on vacuum tubes that may sit on narrow islands. As disclosed herein, automated authentication and cash automation may be used without the need to rebuild drive-up lanes to accommodate the ATMs because current lanes are too narrow to fit drive-up ATMs. The systems sand methods disclosed herein may allow the authentication and interface terminal to remain at the drive-up lane while putting a media storage unit, such as a safe, with valuable media handling modules inside the bank with a teller. Thus, the ATMs and systems disclosed herein may allow for transaction process to be automated and a teller will just need to move money from media storage unit to tube. Still consistent with embodiments disclosed herein, the process of moving banknotes or other valuable media from the media storage unit to the tube also may be automated.

As disclosed herein, ATM heads may allow a user to be authenticated and enter transaction information. Once the transaction information has been processed, media, such as banknotes, can be placed in pneumatic tubes and transferred from the media storage unit to the ATM head. Once at the ATM head, the customer may retrieve the media to complete the transaction.

As disclosed herein, instead of having the media storage unit located with the ATM head, the ATM head, sometimes referred to as the ATM interface, may be manufactured as a compact unit that may be placed on the narrow island of already existing drive-up lanes. This may allow for the dispenser, deposit module or recycler, safe, etc. to be located inside the bank such as inside a bank vault or the teller's room.

As such, the ATM head may communicate with remote modules. The ATM head also may use a smart universal serial bus (USB) hub as a bridge between the local interface, the ATM head, and remote modules, such as currency dispensers, recyclers, etc.

As disclosed herein, the ATM head, which may contain parts approved by customers (e.g. banks) may be installed on the drive-up lane beside the current customer facing tubes (e.g., vacuum tubes. The media storage unit (i.e., the safe) may be installed at the other end of tubes beside the teller station or at another location within the bank.

As disclosed herein, the authentication process and transaction may be processed at the ATM head. For dispense operations, upon completion of transaction, the money may be dispensed at the teller station and the teller may then put it into the tube to be deliver to the customer. For deposit transactions, the teller may retrieve the media (e.g., money/checks) from the tube and deposit it according to company policy and practices.

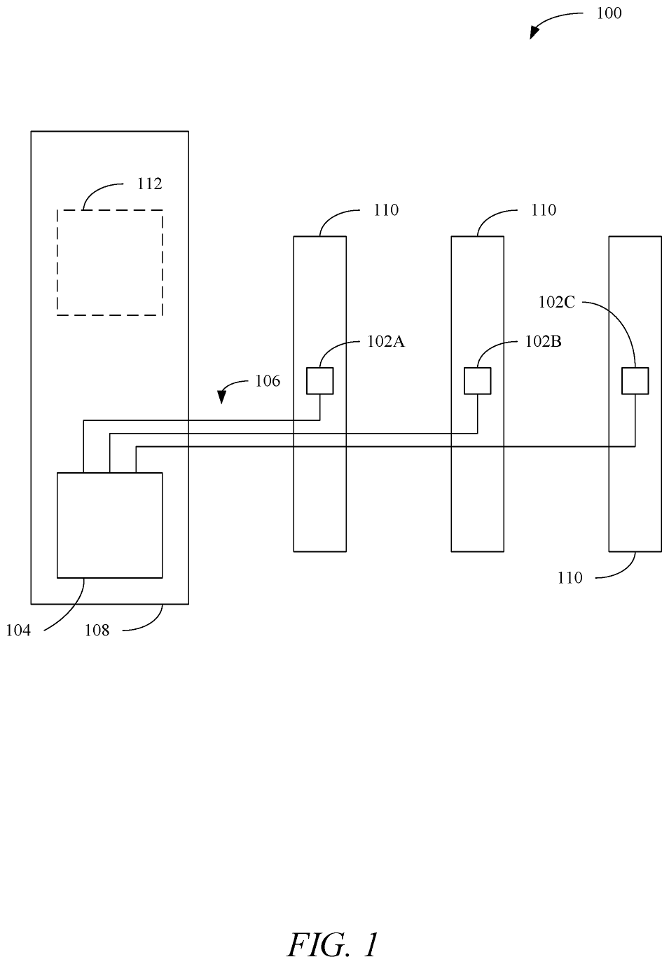

Turning now to the figures, FIG. 1 shows an example schematic of a system 100 consistent with embodiments disclosed herein. As shown in FIG. 1, system 100 may include a first ATM head 102A, a second ATM head 102B, and a third ATM head 102C (collectively, ATM heads 102), a media storage unit 104, and a media tube 106. As disclosed herein, media storage unit 104 may be located remotely from the ATM heads 102. For example, media storage unit 104 may be located in a bank 108. As disclosed herein, media storage unit 104 may be located in various locations with bank 108. For instance, media storage unit 104 may be located in a vault, a teller room, etc. of bank 108. Each of ATM heads 102 may be located on one or more drive-up islands 110.

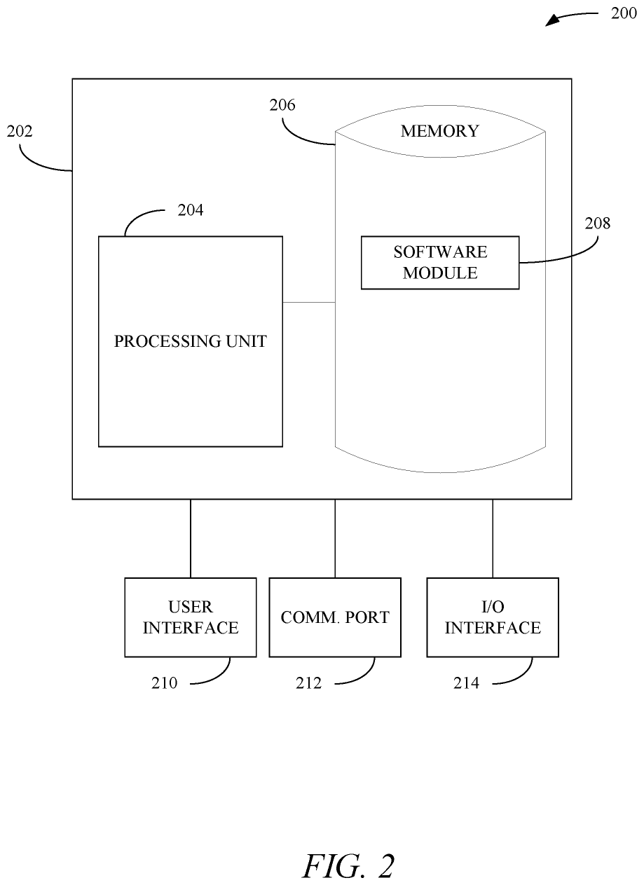

As disclosed herein, ATM heads 102 may include a control as detailed below with respect to FIG. 2. The controller may be integrated with ATM heads 102 such that each of ATM heads 102 includes a controller.

In addition, a controller 112 may be located remote from ATM heads 102 and a single controller, controller 112, may be used to control each of ATM heads 102. For instance, controller 112 may be located inside bank 108, such as in a server room or in a vault. In addition, controller 112 may be located inside media storage unit 104. By having controller 112 located remote from ATM heads, access to controller 112 may be controlled so as to help hinder tampering with controller 112. In addition, the costs for ATM heads 102 may be reduced because ATM heads 102 may include only a display and other components needed to authenticate a user, such as near field communication modules, cameras, pin pads, biometric readers/scanners, etc.

During a transaction, a user may approach one of ATM heads 102, such as first ATM head 102A. For example, the user may drive up to first ATM head 102A. Upon reaching first ATM head 102A, first ATM head 102A may authenticate the user. Authentication of the user may include a user entering a personal identification number (PIN), a user providing biometric information such as one or more finger prints, a retinal scan, swiping a debit/credit card or entering a user name to provide account numbers or other information, etc. In addition, a user may have an image of the user's face stored and first ATM head 102A (or controller 112) may use facial recognition to identify and authenticate the user.

Biometric information may be used in lieu of entering account information. For example, ATM heads 102 may receive a fingerprint using a fingerprint scanner or capture an image of a user using a camera. The biometric information may be used to identify the user and retrieve account information for the user without the user having to produce a debit/credit card or enter a username or other identifying information.

Once the user has been authenticated, the user may enter transaction details. The transaction details may include an amount of money that the user will deposit or withdraw, an amount to be transferred from a first account to a second account, etc. The transaction details and the authentication information may be entered directly into ATM heads 102 or the transaction details and the authentication information may be passed to ATM heads 102 via a mobile device, such as a smartphone, of the user. For example, a user may use an app on his or her smartphone to enter transaction details before the user approaches second ATM head 102B. Once the user approaches second ATM head 102B, the user's smart phone and second ATM head 102B may perform a handshake operation and the user's authentication information and the transaction information may then be transferred to second ATM head 102B.

Once the transaction information has been received, ATM heads 102 (or controller 112) may process the transaction. After the transaction has been processed, media, such as banknotes, may be placed in media tubes 106 for delivery to the user or a teller. For example, once the transaction has been processed, money may be placed in a pod that carries the money through media tubes 106. Once the pod is placed in the appropriate media tube 106, ATM heads 102 or controller 112 may actuate a pneumatic system to cause the pod to travel from the ATM heads 102 to the teller/media storage unit 104 inside bank 108. Communications between ATM heads 102 and tellers, media storage unit 104, controller 112, pneumatic systems, etc. may be wired or wireless.

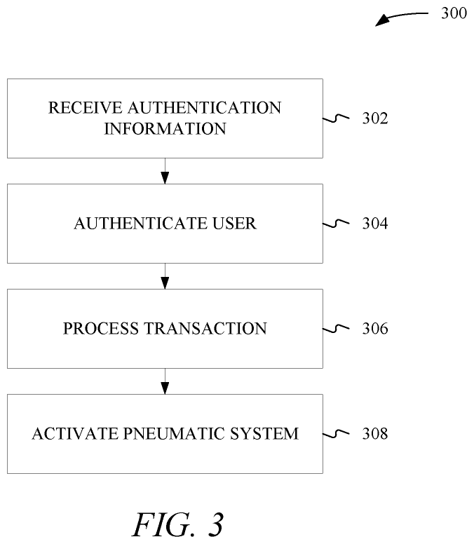

Turning now to FIG. 2, FIG. 2 shows an example schematic of an ATM head 200, such as any one of ATM heads 102. As shown in FIG. 2, ATM head 200 may include controller 202, which may include a processor 204 and a memory 206. Memory 206 may include a software module 208. While executing on processor 204, software module 206 may perform processes for authenticating a user and completing a transaction, including, for example, one or more stages included in a method 300 described below with respect to FIG. 3. ATM head 200 also may include a user interface 210, a communications port 212, and an input/output (I/O) device 214.

As disclosed herein, software module 208 may include instructions that when executed by processor 204 that cause ATM head 200 to retrieve user information from remotes systems. For example, once a user has been authenticated, controller 202 may retrieve account balances, daily withdrawal limits, etc. from a central computer maintained by a financial institution.

User interface 210 can include any number of devices that allow a user to interface with ATM head 200. Non-limiting examples of user interface 210 include a keypad, a microphone, a display (touchscreen or otherwise), etc.

Communications port 212 may allow ATM head 200 to communicate with various information sources and devices, such as, but not limited to, remote computing devices such as servers or other remote computers maintained by financial institutions, mobile devices such as a user's smart phone, peripheral devices, etc. Non-limiting examples of communications port 212 include, Ethernet cards (wireless or wired), Bluetooth® transmitters and receivers, near-field communications modules, etc.

I/O device 214 may allow ATM head 200 to receive and output information. Non-limiting examples of I/O device 214 include, a camera (still or video), fingerprint or other biometric scanners, etc.

Controller 202 may be a component of ATM head 200 and used as disclosed herein to authenticate a user and complete a transaction. In addition, controller 202 may be controller 112 and remote from ATM 200. As a result, controller 202 may communication with multiple ATM heads, such as ATM heads 102, and authenticate multiple user and process multiple transactions simultaneously.

FIG. 3 shows method 300 for authenticating a user and completing a transaction consistent with this disclosure. Method 300 may begin at stage 302 where authentication information may be received. For example, as disclosed herein, the authentication information may be directly entered by the user or the authentication information may be transferred to an ATM head by a user's mobile device.

From stage 302 the method 300 may proceed to stage 304 where the user may be authenticated. For example, once the authentication information has been received, ATM head may authenticate the user to determine that the user is authorized to complete transactions for given accounts.

From stage 304 method 300 may proceed to stage 306 where the transaction may be processed. For example, the user may enter an amount to be deposited or withdrawn from a financial institution. Once the amount to be withdrawn or deposited has been processed, the user's account may be credited/debited accordingly and for withdrawals, cash dispensed from a media storage unit, such as media storage unit 104.

Once the transaction has been processed, method 300 may proceed to stage 308 where controller 202 or controller 112 may activate a pneumatic system associated with media tubes 106. Activation of the pneumatic system may allow a pod containing media, such as banknotes, to travel to or from the ATM head from or to media storage unit 104.

### Examples

Example 1 is an automated teller machine (ATM) comprising: a media storage unit; an ATM head comprising a controller to control operation of the ATM, the controller operable to cause the ATM to perform actions comprising: receiving authentication information associated with a user of the ATM, authenticating the user of the ATM using the authentication information, and processing a transaction after the user has been authenticated, a media tube operatively connecting the media storage unit to the ATM head, wherein the media storage unit is located remotely from the ATM head.

In Example 2, the subject matter of Example 1 optionally includes wherein the media storage unit is located inside a bank vault.

In Example 3, the subject matter of any one or more of Examples 1-2 optionally include wherein the ATM head is located outside of a bank and the media storage unit is located inside the bank.

In Example 4, the subject matter of any one or more of Examples 1-3 optionally include wherein the media tube is a pneumatic tube and the actions further comprise actuating a pneumatic system such that a pod containing media travels from the ATM head to the media storage unit.

In Example 5, the subject matter of any one or more of Examples 1-4 optionally include wherein the media tube is a pneumatic tube and the actions further comprise actuating a pneumatic system such that a pod containing media travels from the media storage unit to the ATM head.

In Example 6, the subject matter of any one or more of Examples 1-5 optionally include wherein authenticating the user includes receiving the authentication from a mobile device of the user.

In Example 7, the subject matter of any one or more of Examples 1-6 optionally include wherein the ATM further includes a camera and authenticating the user includes the controller operable to cause the ATM to perform additional actions comprising using facial recognition using the camera to authenticate the user.

Example 8 is a system comprising: a media storage unit; a plurality of automated teller machine (ATM) heads, each of the ATM heads comprising a controller to control operation of the system, each of the controllers operable to cause a respective ATM head to perform actions comprising: receiving authentication information associated with a user of the system, authenticating the user of the system using the authentication information, and processing a transaction after the user has been authenticated, a media tube operatively connecting the media storage unit to each of the plurality of ATM heads, wherein the media storage unit is located remotely from the plurality of ATM heads.

In Example 9, the subject matter of Example 8 optionally includes wherein the media storage unit is located inside a bank vault.

In Example 10, the subject matter of any one or more of Examples 8-9 optionally include wherein the plurality of ATM heads are located outside of a bank and the media storage unit is located inside the bank.

In Example 11, the subject matter of any one or more of Examples 8-10 optionally include wherein the media tube is a pneumatic tube and the actions further comprise actuating a pneumatic system such that a pod containing media travels from one of the plurality of ATM heads to the media storage unit.

In Example 12, the subject matter of any one or more of Examples 8-11 optionally include wherein the media tube is a pneumatic tube and the actions further comprise actuating a pneumatic system such that a pod containing media travels from the media storage unit to one of the plurality of ATM heads.

In Example 13, the subject matter of any one or more of Examples 8-12 optionally include wherein authenticating the user includes receiving the authentication from a mobile device of the user.

In Example 14, the subject matter of any one or more of Examples 8-13 optionally include wherein the ATM further includes a fingerprint scanner and authenticating the user includes authenticating the user using a fingerprint obtained via the fingerprint scanner.

Example 15 is a system comprising: a media storage unit; a plurality of automated teller machine (ATM) heads, a controller in electrical communication with each of the plurality of ATM heads, the controller operative to perform actions comprising: receiving, from one of the plurality of ATM heads, authentication information associated with a user of the system, authenticating the user of the system using the authentication information, and processing a transaction after the user has been authenticated, a media tube operatively connecting the media storage unit to each of the plurality of ATM heads, wherein the media storage unit is located remotely from the plurality of ATM heads.

In Example 16, the subject matter of Example 15 optionally includes wherein the plurality of ATM heads are located outside of a bank and the media storage unit and controller are located inside the bank.

In Example 17, the subject matter of any one or more of Examples 15-16 optionally include wherein the controller is located remotely from the plurality of ATM heads and the media storage unit.

In Example 18, the subject matter of any one or more of Examples 15-17 optionally include wherein the controller is located inside the media storage unit.

In Example 19, the subject matter of any one or more of Examples 15-18 optionally include wherein the media tube is a pneumatic tube and the actions further comprise: actuating a pneumatic system such that a pod containing first media travels from one of the plurality of ATM heads to the media storage unit; and actuating the pneumatic system such that the pod containing second media travels from the media storage unit to the one of the plurality of ATM heads.

In Example 20, the subject matter of any one or more of Examples 15-19 optionally include wherein authenticating the user includes receiving the authentication from a mobile device of the user.

Example 21 is a method comprising: receiving, at an ATM head, authentication information associated with a user; authenticating, by a controller, the user using the authentication information; processing, by the controller, a transaction; and causing media to travel from a media storage unit to the ATM head, wherein the media storage unit is located remotely from the ATM head.

In Example 22, the subject matter of Example 21 optionally includes wherein the controller is a component of the ATM head.

In Example 23, the subject matter of any one or more of Examples 21-22 optionally include wherein the controller is located remotely from the ATM head.

In Example 24, the subject matter of any one or more of Examples 21-23 optionally include wherein causing the media to travel from the media storage unit to the ATM head includes the controller activating a pneumatic system such that the media travels through a pneumatic tube from the media storage unit to the ATM head.

In Example 25, the subject matter of any one or more of Examples 21-24 optionally include wherein receiving the authentication information includes receiving the authentication from a mobile device of the user.

In Example 26, the subject matter of any one or more of Examples 21-25 optionally include wherein the authentication information includes biometric information.

In Example 27, the subject matter of any one or more of Examples 21-26 optionally include wherein receiving the authentication information includes receiving a fingerprint from a fingerprint scanner electrically coupled to the ATM head.

In Example 28, the subject matter of any one or more of Examples 21-27 optionally include wherein receiving the authentication information includes receiving an image of a face of the user.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

Claimed is:

1. An automated teller machine (ATM) comprising:
a media storage unit;
an ATM head comprising a controller to control operation of the ATM, the controller operable to cause the ATM to perform actions comprising:
receiving authentication information associated with a user of the ATM,
authenticating the user of the ATM using the authentication information, and
processing a transaction after the user has been authenticated,
a media tube operatively connecting the media storage unit to the ATM head,
wherein the media storage unit is located remotely from the ATM head.

2. The ATM of claim 1, wherein the media storage unit is located inside a bank vault.

3. The ATM of claim 1, wherein the ATM head is located outside of a bank and the media storage unit is located inside the bank.

4. The ATM of claim 1, wherein the media tube is a pneumatic tube and the actions further comprise actuating a pneumatic system such that a pod containing media travels from the ATM head to the media storage unit.

5. The ATM of claim 1, wherein the media tube is a pneumatic tube and the actions further comprise actuating a pneumatic system such that a pod containing media travels from the media storage unit to the ATM head.

6. The ATM of claim 1, wherein authenticating the user includes receiving the authentication from a mobile device of the user.

7. The ATM of claim 1, wherein the ATM further includes a camera and authenticating the user includes the controller operable to cause the ATM to perform additional actions comprising using facial recognition using the camera to authenticate the user.

8. A system comprising:
a media storage unit;
a plurality of automated teller machine (ATM) heads, each of the ATM heads comprising a controller to control operation of the system, each of the controllers operable to cause a respective ATM head to perform actions comprising:
receiving authentication information associated with a user of the system,
authenticating the user of the system using the authentication information, and
processing a transaction after the user has been authenticated,
a media tube operatively connecting the media storage unit to each of the plurality of ATM heads,
wherein the media storage unit is located remotely from the plurality of ATM heads.

9. The system of claim 8, wherein the media storage unit is located inside a bank vault.

10. The system of claim 8, wherein the plurality of ATM heads are located outside of a bank and the media storage unit is located inside the bank.

11. The system of claim 8, wherein the media tube is a pneumatic tube and the actions further comprise actuating a pneumatic system such that a pod containing media travels from one of the plurality of ATM heads to the media storage unit.

12. The system of claim 8, wherein the media tube is a pneumatic tube and the actions further comprise actuating a pneumatic system such that a pod containing media travels from the media storage unit to one of the plurality of ATM heads.

13. The system of claim 8, wherein authenticating the user includes receiving the authentication from a mobile device of the user.

14. The system of claim 8, wherein the ATM further includes a fingerprint scanner and authenticating the user includes authenticating the user using a fingerprint obtained via the fingerprint scanner.

15. A system comprising:
a media storage unit;
a plurality of automated teller machine (ATM) heads,
a controller in electrical communication with each of the plurality of ATM heads, the controller operative to perform actions comprising:
receiving, from one of the plurality of ATM heads, authentication information associated with a user of the system,
authenticating the user of the system using the authentication information, and
processing a transaction after the user has been authenticated,
a media tube operatively connecting the media storage unit to each of the plurality of ATM heads,
wherein the media storage unit is located remotely from the plurality of ATM heads.

16. The system of claim 15, wherein the plurality of ATM heads are located outside of a bank and the media storage unit and controller are located inside the bank.

17. The system of claim 15, wherein the controller is located remotely from the plurality of ATM heads and the media storage unit.

18. The system of claim 15, wherein the controller is located inside the media storage unit.

19. The system of claim 15, wherein the media tube is a pneumatic tube and the actions further comprise:
actuating a pneumatic system such that a pod containing first media travels from one of the plurality of ATM heads to the media storage unit; and
actuating the pneumatic system such that the pod containing second media travels from the media storage unit to the one of the plurality of ATM heads.

20. The system of claim 15, wherein authenticating the user includes receiving the authentication from a mobile device of the user.
